(19) United States
(12) Patent Application Publication
(10) Pub. No.: US 2026/0253859 A1
(43) Pub. Date: Aug. 27, 2026

(54) APPARATUS AND METHOD FOR TRAPPING IONS

(71) Applicant: Thermo Finnigan LLC, San Jose, CA (US)

(72) Inventors: Joshua A. Silveira, Gilroy, CA (US); Chandika Amarasinghe, Milpitas, CA (US); Robert Louis Schrader, San Jose, CA (US)

(21) Appl. No.: 19/059,986

(22) Filed: Feb. 21, 2025

(51) Int. Cl. H01J 49/42

(52) U.S. Cl. CPC H01J 49/4225; H01J 49/427; H01J 49/4295

(57) ABSTRACT

An illustrative ion trap comprises a first group of ring-shaped electrodes that are centered around an ion trap central axis and that define a first annular trapping volume, and a second group of ring-shaped electrodes that are centered around the ion trap central axis and that define a second annular trapping volume. Upon receipt of radio frequency (RF) voltages, the first group of ring-shaped electrodes and the second group of ring-shaped electrodes generate a first pseudo-potential barrier and a second pseudo-potential barrier. The first pseudo-potential barrier is configured to prevent the ions from escaping the first annular trapping volume and the second annular trapping volume in an axial direction through an exit. The second pseudo-potential barrier is positioned between the first annular trapping volume and the second annular trapping volume. The second pseudo-potential barrier is weaker than the first pseudo-potential barrier.

### BACKGROUND INFORMATION

Mass spectrometry has often been referred to as a “Gold Standard” tool for the identification and analysis of various classes of compounds. In no small measure, the power of mass spectrometry resides in the ability of modern mass spectrometers to separately isolate, store, and subsequently manipulate-via ion fragmentation or ion-ion chemical reaction-specific ion species of interest that are chosen from among the multitude of ion species that are generally produced by ionization of any sample mixture. In many types of mass spectrometers, quadrupole mass filters are often employed to perform the ion isolation function. For example, in a mass spectrometer of the triple-quadrupole type or the quadrupole-time-of-flight (Q-TOF) type, a mass filter is disposed upstream from a mass analyzer. The mass filter receives a stream of ions composed of a variety of ion species comprising a variety of mass-to-charge (m/z) ratios. To isolate a particular ion species comprising a specific m/z, a specific pair of direct-current (DC) and oscillatory radio-frequency (RF) voltages is applied to rod electrodes of the mass filter. The application of DC and RF voltages of the appropriate magnitude permits transmission, through the mass filter, of only a narrow range of m/z values that encompasses the specific m/z of interest. Under such operation, ions having all other m/z values are ejected from the apparatus and neutralized. The ion species that comprises the specific m/z that is of interest is thus transmitted, without significant contamination from other ion species, through the mass filter and guided to other, downstream mass spectrometer components that may manipulate and analyze ions of the isolated ion species in various ways.

Examples of ion guides and ion traps in mass spectrometry systems include atmospheric pressure interface transfer optics, multipoles to transfer ions between different analyzer sections, higher energy collisional dissociation (HCD) and collision-induced dissociation (CID) cells, and others. Stacked ring ion guides are conventionally known and comprise a plurality of ring electrodes each having an aperture through which ions are transmitted. The ion confining region of conventional stacked ring ion guides is circular in cross section. Ion traps include an ion confining region in which ions are trapped by application of DC and RF voltages to electrodes of the ion traps. Only ions of a certain m/z will be able to pass through the ion confining region and reach a detector for a given ratio of DC and RF voltages. This allows selection of an ion with a particular m/z or allows the operator to scan for a range of m/z values by continuously varying the applied DC and RF voltages.

The limited space charge capacity of conventional ion traps and ion guides can result in a loss of transmission or sensitivity due to inefficient ion confinement, which leads to ion losses. Furthermore, although conventional ion traps are capable of scheduling ions upstream of a mass selection device, the synchronization of such scheduling devices is principally limited by the charge capacity. Increasing the charge capacity of certain ion trap configurations may involve significantly enlarging the diameter of the ion trap which will, consequently, undesirably elongate the exit ion guide. It is therefore desired to provide an improved ion trap.

### SUMMARY

The following description presents a simplified summary of one or more aspects of the systems and methods described herein. This summary is not an extensive overview of all contemplated aspects and is intended to neither identify key or critical elements of all aspects nor delineate the scope of any or all aspects. Its sole purpose is to present one or more aspects of the systems, apparatus, and methods described herein as a prelude to the detailed description that is presented below.

An illustrative ion trap comprises a first group of ring-shaped electrodes that are centered around an ion trap central axis and that define a first annular trapping volume, the first annular trapping volume located at a first distance from the ion trap central axis; a second group of ring-shaped electrodes that are centered around the ion trap central axis and that define a second annular trapping volume, the second annular trapping volume located at a second distance from the ion trap central axis, the second distance being less than the first distance; an entrance through which ions are added to at least one of the first annular trapping volume or the second annular trapping volume; and an exit through which the ions exit the first annular trapping volume and the second annular trapping volume in an axial direction, wherein: upon receipt of radio frequency (RF) voltages, the first group of ring-shaped electrodes and the second group of ring-shaped electrodes generate a first pseudo-potential barrier and a second pseudo-potential barrier; the first pseudo-potential barrier is positioned at the exit of the ion trap and is configured to prevent the ions within the first annular trapping volume and the ions within the second annular trapping volume from escaping the first annular trapping volume and the second annular trapping volume in the axial direction through the exit; the second pseudo-potential barrier is positioned between the first annular trapping volume and the second annular trapping volume and is configured to urge the ions within the second annular trapping volume away from the first annular trapping volume; and the second pseudo-potential barrier is weaker than the first pseudo-potential barrier.

An illustrative mass spectrometry system comprises a mass filter; and an ion trap positioned upstream of the mass filter, the ion trap comprising: a first group of ring-shaped electrodes that are centered around an ion trap central axis and that define a first annular trapping volume, the first annular trapping volume located at a first distance from the ion trap central axis; and a second group of ring-shaped electrodes that are centered around an ion trap central axis and that define a second annular trapping volume, the second annular trapping volume located at a second distance from the ion trap central axis, the second distance being less than the first distance.

An illustrative method comprises applying, by a mass spectrometry system, radio frequency (RF) voltages to a first group of ring-shaped electrodes of an ion trap and a second group of ring-shaped electrodes of the ion trap to generate a first pseudo-potential barrier and a second pseudo-potential barrier, wherein: the first group of ring-shaped electrodes are centered around a central axis of the ion trap and define a first annular trapping volume; the second group of ring-shaped electrodes are centered around the central axis of the ion trap and define a second annular trapping volume; the first group of ring-shaped electrodes and the second group of ring-shaped electrodes are concentric about the central axis of the ion trap; the first pseudo-potential barrier is positioned at an exit of the ion trap and is configured to prevent ions from escaping the ion trap in an axial direction through the exit; the second pseudo-potential barrier is positioned between the first annular trapping volume and the second annular trapping volume; and the second pseudo-potential barrier is weaker than the first pseudo-potential barrier; and accumulating, by the mass spectrometry system, ions within the ion trap.

An illustrative non-transitory computer-readable medium stores instructions that, when executed, direct a processor of a computing device to perform a process comprising: applying, by a mass spectrometry system, radio frequency (RF) voltages to a first group of ring-shaped electrodes of an ion trap and a second group of ring-shaped electrodes of the ion trap to generate a first pseudo-potential barrier and a second pseudo-potential barrier, wherein: the first group of ring-shaped electrodes are centered around a central axis of the ion trap and define a first annular trapping volume; the second group of ring-shaped electrodes are centered around the central axis of the ion trap and define a second annular trapping volume; the first group of ring-shaped electrodes and the second group of ring-shaped electrodes are concentric about the central axis of the ion trap; the first pseudo-potential barrier is positioned at an exit of the ion trap and is configured to prevent ions from escaping the ion trap in an axial direction through the exit; the second pseudo-potential barrier is positioned between the first annular trapping volume and the second annular trapping volume; and the second pseudo-potential barrier is weaker than the first pseudo-potential barrier; and accumulating, by the mass spectrometry system, ions within the ion trap.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 is a block diagram of an illustrative mass spectrometer platform that may be implemented according to principles described herein.

FIG. 2A is a front view of an illustrative ion trap that may be implemented according to principles described herein.

FIG. 2B is a cross-sectional view of the illustrative ion trap taken along line 2B shown in FIG. 2A.

FIGS. 2C-2E show different illustrative cross-sectional configurations of ion traps that may be implemented according to principles described herein.

FIG. 3 is a perspective cross-sectional view of the illustrative ion trap shown in FIG. 2A and an ion guide according to principles described herein.

FIG. 4 is a schematic depiction of pseudo-potential barriers that may be implemented by ion traps according to principles described herein.

FIG. 5 depicts illustrative graphs that show elution field magnitudes of different annular trapping volumes for different m/z ratios according to principles described herein.

FIG. 6 depicts a mass spectrometry system that may be implemented according to principles described herein.

FIG. 7 shows an illustrative method.

FIG. 8 shows an illustrative computing device that may be implemented according to principles described herein.

### DETAILED DESCRIPTION

The present application relates to mass spectrometers and mass spectrometry. More particularly, the present application relates to ion traps and ion separation devices that are employed in mass spectrometers and to methods of use of such ion traps and ion separation devices within mass spectrometers.

In the description herein, it is understood that a word appearing in the singular encompasses its plural counterpart, and that a word appearing in the plural encompasses its singular counterpart, unless implicitly or explicitly understood or stated otherwise. Furthermore, it is understood that, for any given component or embodiment described herein, any of the possible candidates or alternatives listed for that component may generally be used individually or in combination with one another, unless implicitly or explicitly understood or stated otherwise. Moreover, it is to be appreciated that the figures, as shown herein, are not necessarily drawn to scale, wherein some of the elements may be drawn merely for clarity of the invention. Also, reference numerals may be repeated among the various figures to show corresponding or analogous elements. Additionally, it will be understood that any list of candidates or alternatives is merely illustrative, not limiting, unless implicitly or explicitly understood or stated otherwise.

Unless otherwise defined, all other technical and scientific terms used herein have the meaning commonly understood by one of ordinary skill in the art to which this invention belongs. In case of conflict, the present specification, including definitions, will control. It will be appreciated that there is an implied “about” prior to any quantitative terms mentioned in the present description, such that slight and insubstantial deviations are within the scope of the present teachings. In addition, the use of “comprise”, “comprises”, “comprising”, “contain”, “contains”, “containing”, “include”, “includes”, and “including” are not intended to be limiting. As used herein, “a” or “an” also may refer to “at least one” or “one or more.” Also, the use of “or” is inclusive, such that the phrase “A or B” is true when “A” is true, “B” is true, or both “A” and “B” are true.

As used herein, the term “DC”, when referring to a voltage applied to one or more electrodes of a mass spectrometer component (such as an ion trap or ion funnel), does not necessarily imply the imposition of or the existence of an electrical current through those electrodes. The term “DC” is thus used herein to distinguish the referred-to voltage(s) from applied oscillatory voltages that oscillate at radio frequencies and that, themselves, are referred to as “RF” voltages.

As used herein, the term “static”, as applied to a DC electric field (a vector field) or to an RF amplitude, refers to a DC field or an RF amplitude that is maintained essentially unchanging with time during a period of time, possibly with inconsequential variations of not greater than ten percent of an average field strength or an average RF amplitude. The term “uniform”, as applied to a DC field, refers to a DC field that is maintained so as to have a magnitude and a direction that do not substantially vary, other than inconsequential statistical variations, across a span encompassing a series of electrodes; for example, across a series of electrodes spanning a length of an ion optical component from an ion entrance end to an ion exit end. Conversely, the terms “gradient” and “non-uniform”, as applied to a DC field, refer, respectively, to a spatial variation, spanning a series of electrodes, of at least a magnitude of a DC field and to a DC field that is caused to exhibit such a variation. It should be noted that a “static” DC field may either be uniform or may have a gradient. The term “uniform”, as applied to an RF amplitude, refers to an RF amplitude that is maintained so as to not substantially vary across a span encompassing a series of electrodes. Conversely, the terms “gradient” and “non-uniform”, as applied to an RF amplitude, refers to a spatial variation, spanning a series of electrodes, of the applied amplitude.

As used herein, the terms “dynamic” and “ramped”, as applied to either a DC field or an RF amplitude, refer to a DC field or an RF amplitude that is caused to vary with time, in either a monotonically increasing fashion or a monotonically decreasing fashion, over a period of time. The ramping of the magnitude of a DC field that is applied across a series of electrodes requires the ramping of a DC potential that is applied to a subset (i.e., to one or more) of those electrodes. Similarly, the ramping of an RF amplitude of RF waveforms that are applied across a series of electrodes requires the ramping of an RF amplitude that is applied to one or more of those electrodes.

A DC field or RF amplitude that is maintained in a static state over a first time period may, at other times that occur either before or after the time period, be maintained in a dynamic or ramped state and vice versa. Likewise, a DC field or RF amplitude that is maintained in a uniform state over a first time period may, at other times, be maintained in a non-uniform state and vice-versa. As used herein, the terms “urge” and “urges”, when used in relation to the effect, upon an ion or ions, of a direction of an applied force, do not necessarily imply that the ion or ions are caused to move in that direction in response to the force, since the direction of movement of any ion at the time of application of a force depends on its initial momentum vector as well as the vector sum of all such applied forces.

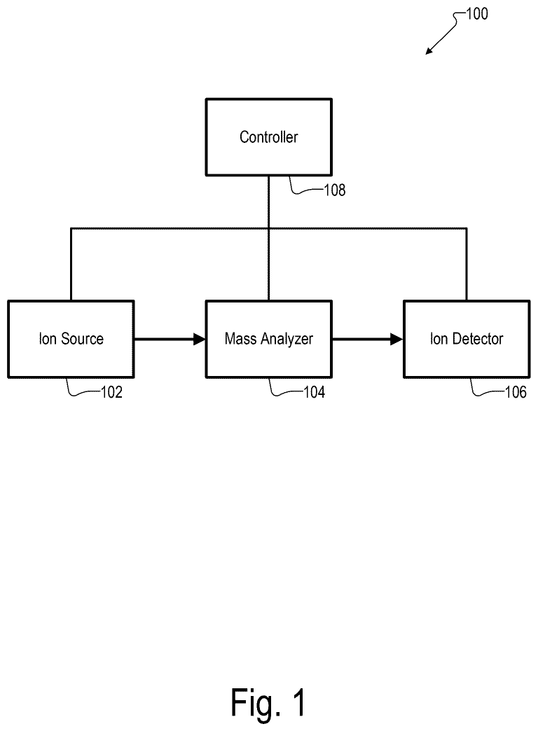

FIG. 1 depicts an illustrative mass spectrometer platform 100 that may be implemented according to principles described herein. As shown in FIG. 1, mass spectrometer platform 100 includes an ion source 102, a mass analyzer 104, an ion detector 106, and a controller 108. Ion source 102 generates a plurality of ions from a sample. The ion source can include, but is not limited to, an atmospheric pressure ionization (API) source, an electron ionization (EI) source, a chemical ionization (CI) source, an electrospray ionization (ESI) source, an atmospheric pressure chemical ionization (APCI) source, or a matrix assisted laser desorption ionization (MALDI) sources. The ion source can be interfaced to a separation device upstream of the ion source, such as a liquid chromatography (LC) system, an ion chromatography (IC) system, a gas chromatography (GC) system, a capillary zone electrophoresis (CZE) system, a two-dimensional GC (GC×GC) system, a two-dimensional LC (LC×LC) system, which are all herein termed chromatographic devices.

In certain examples, the mass analyzer 104 may separate ions based on m/z of the ions and/or the ion mobility. By way of non-limiting example, mass analyzer 104 may include a mass filter analyzer, an ion trap mass analyzer (e.g., a three-dimensional multipole ion trap, quadrupole ion trap, a cylindrical ion trap, a linear quadrupole ion trap, a toroidal ion trap, etc.), a time-of-flight (TOF) mass analyzer, an electrostatic trap mass analyzer (e.g., an electrostatic linear ion trap (ELIT) mass analyzer or an orbital electrostatic trap mass analyzer, such as an Orbitrap™ mass analyzer (Thermo Fisher Scientific, Waltham, MA) or a Kingdon trap), or a Fourier transform ion cyclotron resonance (FT-ICR) mass analyzer. In some examples, mass analyzer 104 may be configured to fragment the ions using collision-induced dissociation (CID), higher-energy collisional dissociation (HCD), electron transfer dissociation (ETD), electron capture dissociation (ECD), photo induced dissociation (PID), surface induced dissociation (SID), and the like, and further separate the fragmented ions based on the m/z. Mass analyzer 104 may also be a hybrid system incorporating one or more mass analyzers and mass separators coupled by various combinations of ion optics and storage devices. For example, a hybrid system may have a linear ion trap (LIT), a high energy collision dissociation (HCD) device, an ion transport system, and a TOF mass analyzer.

Ion detector 106 may be configured to detect ions in any suitable manner. For example, ion detector 106 may include an electron multiplier, a Faraday cup, or the like. In certain examples, ion detector 106 may be quantitative, such that an accurate count of the ions can be determined. In other examples, such as with an electrostatic trap mass analyzer, the mass analyzer detects the ions, combining the properties of both the mass analyzer 104 and the ion detector 106 into one device.

As shown in FIG. 1, controller 108 communicates with ion source 102, mass analyzer 104, and ion detector 106. For example, controller 108 may configure ion source 102 or enable/disable ion source 102 based on various factors. In certain examples, controller 108 may configure mass analyzer 104 to select a particular mass range to detect. Further, the controller 108 may adjust the sensitivity of ion detector 106, such as by adjusting the gain. Additionally, controller 108 may adjust the polarity of ion detector 106 based on the polarity of the ions being detected. For example, ion detector 106 may be configured to detect positive ions or be configured to detect negative ions. Additionally, controller 108 may be configured to control phases of loading, storing, and eluting ions from an ion trap in any suitable manner. For example, controller 108 may selectively and controllably lower an entrance-side pseudo-potential barrier of an ion trap during loading of ions and raise the entrance-side pseudo-potential barrier while storing the ions in the ion trap.

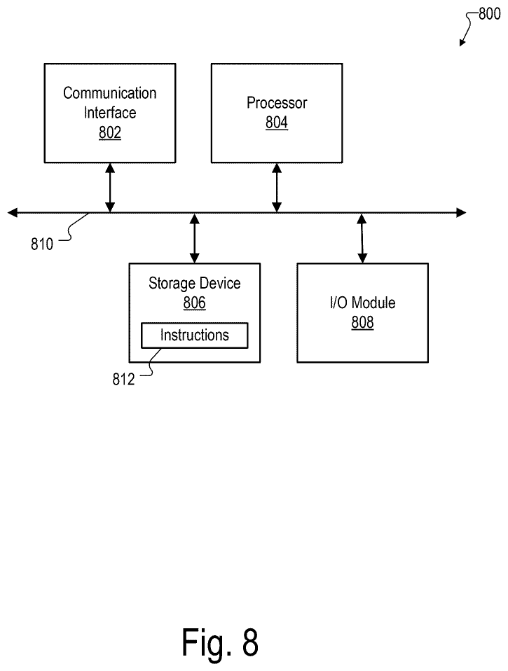

Examples of computing devices that may, singularly or in combination, implement the mass spectrometer platform 100 (e.g., controller 108) are discussed herein with reference to a computing device 800 of FIG. 8, and examples of systems of interconnected computing devices, in which mass spectrometer platform 100 may be implemented across one or more additional computing devices.

Quadrupole mass spectrometers traditionally generate mass spectra by using a nearly constant RF/DC ratio whose RF and DC amplitudes are nearly linearly scaled in time. This process, as would be understood by one of ordinary skill in the art, essentially produces a shifting pass-band filter where ions of different ranges of m/z are stable and allowed to pass through and into a detector. This passband can be defined by the a and q values that are solutions to the Mathieu equation.

Quadrupoles and ion traps are routinely used for ion selection during a mass spectrometry session. Ion traps allow for a large number of ions, with varying mass and charge, to be injected into the system. The injected ions are generally contained in an ion trap (e.g., trapped inside a ring-shaped quadrupolar potential). The ions can then be selectively released as the RF voltage of the trap is ramped down, or as the DC voltage, which creates an axial field, is ramped up. The ions can be selected for elution based on m/z and/or an ion mobility factor. The m/z of an ion is simply the mass of the atom divided by its charge and is generally expressed in kilogram (kg) per coulombs (C) or Dalton (Da) per elementary charge (e). Alternatively, ion mobility is determined based on the average speed (e.g., velocity) that a specific ion passes through a known gas, while under the influence of an electric field, and is generally expressed in meters per second per volt per meter (m/s/V/m or (ms⁻¹(V/m⁻¹)⁻¹)).

The ion traps described herein have improved charge capacity as compared to other ring-shaped ion traps. With the ion traps described herein, it is possible to minimally increase the diameter of the ion traps while greatly increasing the charge capacity. For example, the diameter of an ion trap configured as described herein may only increase by 4.2× as compared to other ring-shaped ion traps but may result in a 14× increase in charge capacity. Improving the charge capacity facilitates more flexible timing and/or scheduling schemes with downstream devices. Further, improving charge capacity facilitates storing the ions for relatively longer periods of time, which increases flexibility with respect to the scan speed that is chosen. In addition, the improved charge capacity facilitates relatively longer scan times that allow for higher resolving power without sacrificing the duty cycle. The ion traps described herein include a plurality of groups of ring-shaped electrodes that are centered around an ion trap central axis and that define a plurality of annular trapping volumes. The ion traps described herein include any suitable number of annular trapping volumes as may serve a particular implementation. For example, an ion trap may include only two annular trapping volumes in certain implementations. In such examples, the ion trap includes a first group of ring-shaped electrodes that are centered around an ion trap central axis and that define a first annular trapping volume and a second group of ring-shaped electrodes that are centered around the ion trap central axis and that define a second annular trapping volume. The first annular trapping volume is located at a first distance from the ion trap central axis. The second annular trapping volume is located at a second distance from the ion trap central axis. The second distance is less than the first distance.

In certain examples, the groups of ring-shaped electrodes correspond to quadrupoles in which four ring-shaped electrodes are provided in each group of ring-shaped electrodes. Various alternative implementations may exist in which the ring-shaped electrodes comprise a relatively larger group of electrodes (e.g., hexapole, octapole, or higher order multipoles).

In certain examples, at least two ring-shaped electrodes included in the first group of ring-shaped electrodes are included in the second group of ring-shaped electrodes. In such examples, the first group of ring-shaped electrodes may comprise a first quadrupole formed of a first ring-shaped electrode, a second ring-shaped electrode, a third ring-shaped electrode, and a fourth ring-shaped electrode. The second group of ring-shaped electrodes may comprise a second quadrupole formed of the third ring-shaped electrode, the fourth ring-shaped electrode, a fifth ring-shaped electrode, and a sixth ring-shaped electrode.

The ion trap may further include an entrance through which ions may be added to at least one of the first annular trapping volume or the second annular trapping volume. The entrance of an ion trap may be configured in any suitable manner as may serve a particular implementation. In certain examples, an ion trap includes a single entrance through which ions may be added in any suitable manner into one of the annular trapping volumes. For example, an ion trap may include a single entrance point through which ions may be added to the second annular trapping volume. In such examples, the accumulating of the ions within the ion trap may include accumulating ions within the innermost annular trapping volume (e.g., the second annular trapping volume or an additional annular trapping volume) before accumulating the ions within a relatively more outward annular trapping volume (e.g., the first annular trapping volume). In certain alternative examples, the entrance is located at a position other than the innermost annular trapping volume. For example, the accumulating of the ions within the ion trap may include accumulating ions within the outermost annular trapping volume (e.g., the first annular trapping volume) before accumulating the ions within a relatively more inward annular trapping volume (e.g., the second annular trapping volume). In certain alternative implementations, an ion trap may include a plurality of entrances through which ions may be added to a plurality of annular trapping volumes.

The ion trap may further include an exit through which the ions exit the first annular trapping volume and the second annular trapping volume in an axial direction. Ions may be configured to exit the ion trap through the exit in any suitable manner such as described herein.

Ions may be accumulated within the annular trapping volumes through the use of pseudopotential barriers. In particular, upon receipt of radio frequency (RF) voltages, the first group of ring-shaped electrodes and the second group of ring-shaped electrodes may generate a first pseudo-potential barrier and a second pseudo-potential barrier. The first pseudo-potential barrier may be positioned at the exit of the ion trap and may be configured to prevent the ions within the first annular trapping volume and the ions within the second annular trapping volume from escaping the first annular trapping volume and the second annular trapping volume in the axial direction through the exit. The second pseudo-potential barrier may be positioned between the first annular trapping volume and the second annular trapping volume and may be configured to urge the ions within the second annular trapping volume away from the first annular trapping volume (and vice versa). The second pseudo-potential barrier is configured to be weaker than the first pseudo-potential barrier. With such a configuration, ions may migrate across the second pseudo-potential barrier and accumulate within radially adjacent annular trapping volumes before escaping across the first pseudo-potential barrier and through the exit of the ion trap.

The pseudo-potential barriers may be generated in any suitable manner. For example, an alternating current (AC) or radio frequency (RF) signal generator, or power supply, may be connected to outer electrodes and inner electrodes in opposite phases (e.g., +RF may be connected to the inner electrodes and −RF may be connected to the outer electrodes). Accordingly, because opposing RF power is applied to the outer electrodes and the inner electrodes, a radially confining pseudo-potential barrier may be generated to confine ions within annular trapping volumes.

In certain examples, the second annular trapping volume is configured to receive ions through the entrance. At least a portion of the ions within the second annular trapping volume may preferentially migrate, across the second pseudo-potential barrier instead of the first pseudo-potential barrier, from the second annular trapping volume to the first annular trapping volume while the first annular trapping volume accumulates ions.

In certain examples, the ion trap is configured such that ions only accumulate in an annular trapping volume by migrating across a pseudo-potential barrier from another annular trapping volume. For example, ions may only be accumulated in the first annular trapping volume after the ions migrate from the second annular trapping volume to the first annular trapping volume across the second pseudo-potential barrier. In these examples, there is no external entrance to the first annular trapping volume.

In certain examples, an ion trap includes three or more annular trapping volumes. In such examples, the ion trap may include a third group of ring-shaped electrodes that are centered around the ion trap central axis and that define a third annular trapping volume. The third annular trapping volume may be located at a third distance from the ion trap central axis, the third distance being less than the second distance. Upon receipt of the RF voltages, the third group of ring-shaped electrodes may generate a third pseudo-potential barrier. The third pseudo-potential barrier may be positioned between the second annular trapping volume and the third annular trapping volume and may be configured to urge the ions within the third annular trapping volume away from the second annular trapping volume (and vice versa). In certain examples, the third pseudo-potential barrier has substantially the same magnitude as the second pseudo-potential barrier. In alternative examples, the third pseudo-potential barrier may be relatively weaker than or stronger than the second pseudo-potential barrier.

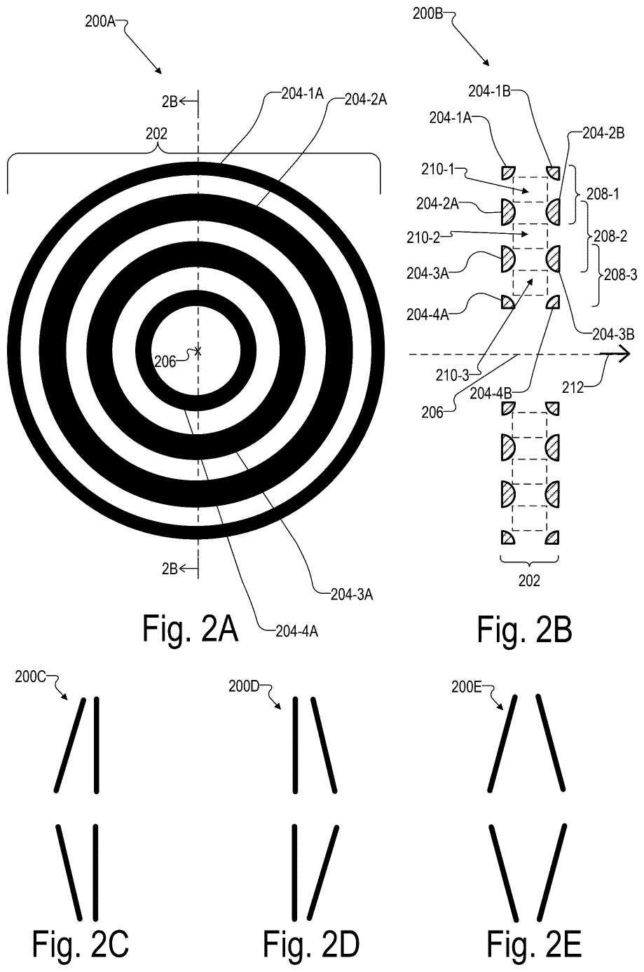

FIGS. 2A and 2B depict views 200A and 200B of an illustrative configuration of an ion trap 202 that includes three annular trapping volumes. While an example ion trap 202 with three annular trapping volumes is shown and described herein, it will be understood that ion traps 202 according to the present disclosure can have fewer (e.g., two) or greater (e.g., four, five, six...) annular trapping volumes and that the illustration and description of three annular trapping volumes in the ion trap 202 is done herein for reasons of economy. View 200A shown in FIG. 2A is a front view of ion trap 202. As shown in FIG. 2A, ion trap 202 includes a plurality of ring-shaped electrodes 204 (e.g., ring-shaped electrodes 204-1A, 204-2A, 204-3A, and 204-4A). In the example shown in FIG. 2A, ring-shaped electrodes 204 have a circular shape. However, it is understood that ring-shaped electrodes 204 may have a different shape (e.g., oval, elliptical, rectangular, square, triangular, etc.) in alternative implementations.

View 200B shown in FIG. 2B is a cross-sectional view taken along line 2B-2B shown in FIG. 2A. As shown in FIG. 2B, ion trap 202 includes additional ring-shaped electrodes 204 (e.g., ring-shaped electrodes 204-1B, 204-2B, 204-3B, and 204-4B) adjacent to those shown in FIG. 2A. Ring-shaped electrodes 204 define a plurality of groups of ring-shaped electrodes that are centered about an ion trap central axis 206. For example, a first group 208-1 of ring-shaped electrodes includes ring-shaped electrodes 204-1A, 204-1B, 204-2A, and 204-2B, a second group 208-2 of ring-shaped electrodes includes ring-shaped electrodes 204-2A, 204-2B, 204-3A, and 204-3B, and a third group 208-3 of ring-shaped electrodes includes ring-shaped electrodes 204-3A, 204-3B, 204-4A, and 204-4B. Accordingly, in the example shown in FIGS. 2A and 2B, at least some of the ring-shaped electrodes 204 included in one of the groups 208 (e.g., electrodes 204-2A and 204-2B of first group 208-1) are also included in another group (e.g., second group 208-2). Each of groups 208 may be considered as a multipole device (e.g., a quadrupole).

First group 208-1 defines a first annular trapping volume 210-1, second group 208-2 defines a second annular trapping volume 210-2, and third group 208-3 defines a third annular trapping volume 210-3. As shown in FIG. 2B, first annular trapping volume 210-1 is located at a first distance from ion trap central axis 206. Second annular trapping volume 210-2 is located at a second distance from ion trap central axis 206, the second distance being less than the first distance. Third annular trapping volume 210-3 is located at a third distance from ion trap central axis 206, the third distance being less than the second distance. Annular trapping volumes 210 are shown as having a rectangular cross section for illustrative purposes only. It is understood that annular trapping volumes 210 may have any suitable cross-sectional shape or define any suitable region between electrodes 204 as may serve a particular implementation. In addition, in the example shown in FIGS. 2A and 2B, it is understood that annular trapping volumes 210 are in the shape of concentric rings that each separately encircle an ion trap central axis 206 at different distances from the ion trap central axis 206. Arrow 212 shown in FIG. 2B depicts an axial direction of ion trap 202.

In the example shown in FIG. 2B, ring-shaped electrodes 204 are arranged in a parallel configuration when viewed in cross section. For example, the upper half of ring-shaped electrodes 204-1A through 204-4A are arranged on a same imaginary plane that is parallel to a same imaginary plane on which the upper half of ring-shaped electrodes 204-1B through 204-4B are arranged. Likewise, the lower half of ring-shaped electrodes 204-1A through 204-4A are arranged on a same imaginary plane that is parallel to an imaginary plane on which the lower half of ring-shaped electrodes 204-1B through 204-4B are arranged. With such a configuration it is possible to facilitate simultaneously ejecting ions from the exit of ion trap 202 from each of annular trapping volumes 210.

Ring-shaped electrodes 204 may be arranged in other non-parallel configurations, when viewed in cross section. For example, one or more imaginary planes on which a set of ring-shaped electrodes 204 are arranged may be angled with respect to one or more other imaginary planes on which other sets of ring-shaped electrodes 204 are arranged, when viewed in cross section. To illustrate an example, in certain implementations, the upper half and the lower half of ring-shaped electrodes 204-1B through 204-4B may be arranged on a same plane, as shown in FIG. 2B. However, the upper half of ring-shaped electrodes 204-1A through 204-4A (i.e., ring-shaped electrodes at the entrance to the ion trap) may be arranged on an imaginary plane that is angled with respect to the imaginary plane on which the upper half of ring-shaped electrodes 204-1B through 204-4B (i.e., ring-shaped electrodes at the exit to the ion trap) are arranged. Likewise, the lower half of ring-shaped electrodes 204-1A through 204-4A may be arranged on an imaginary plane that is angled with respect to the imaginary plane on which the lower half of ring-shaped electrodes 204-1B through 204-4B are arranged. With such a configuration, the outermost ring-shaped electrodes 204-1A and 204-1B are closer together in the axial direction than the innermost ring-shaped electrodes 204-4A and 204-4B on both the upper and lower halves. Such a configuration may be beneficial because relatively higher m/z ions may be ejected from first annular trapping volume 210-1 before relatively lower m/z ions are ejected from second annular trapping volume 210-2 or third annular trapping volume 210-3, as explained below. A simplified version of this configuration of non-parallel imaginary planes is shown in FIG. 2C as configuration 200C.

In another example, the upper half and the lower half of ring-shaped electrodes 204-1A through 204-4A (i.e., ring-shaped electrodes at the entrance to the ion trap) may be arranged on a same imaginary plane, as shown in FIG. 2B when viewed in cross section. However, the upper half of ring-shaped electrodes 204-1B through 204-4B (i.e., ring-shaped electrodes at the exit to the ion trap) may be arranged on an imaginary plane that is angled with respect to the imaginary plane on which the upper half of ring-shaped electrodes 204-1A through 204-4A are arranged. Likewise, the lower half of ring-shaped electrodes 204-1B through 204-4B may be arranged on an imaginary plane that is angled with respect to the imaginary plane on which the lower half of ring-shaped electrodes 204-1A through 204-4A are arranged. A simplified version of this configuration of non-parallel imaginary planes is shown in FIG. 2D as configuration 200D.

In certain alternative implementations, imaginary planes on which the upper half and the lower half of both ring-shaped electrodes 204-1A through 204-4A (i.e., ring-shaped electrodes at the entrance to the ion trap) and ring-shaped electrodes 204-1B through 204-4B (i.e., ring-shaped electrodes at the exit to the ion trap) are arranged at an angle with respect to each other when viewed in cross section. With such a configuration, the outermost ring-shaped electrodes 204-1A and 204-1B are closer together in the axial direction than the innermost ring-shaped electrodes 204-4A and 204-4B on both the upper and lower halves. A simplified version of this configuration of non-parallel imaginary planes is shown in FIG. 2E as configuration 200E.

The different configurations shown in FIGS. 2A-2E are provided for illustrative purposes. It is understood that ring-shaped electrodes may be arranged at any suitable angle with respect to one another or an imaginary plane orthogonal to the axial direction when viewed in cross-section as may serve a particular implementation. For example, the angle of a cross-section of the ring-shaped electrodes with respect to an imaginary plane orthogonal to the axial direction may each individually be an angle between 1° to 5°, 1° to 10°, 1° to 15°, 1° to 20°, 1° to 25°, 1° to 30° (all angles inclusive), or any other suitable angle or angle range. Additionally or alternatively, ring-shaped electrodes 204 may have cross sectional profiles in which they are not positioned on the same imaginary plane. For example, in certain alternative configurations, ring-shaped electrodes 204 may be positioned on imaginary curved surface(s) that may be oriented and/or configured in any suitable manner.

As shown in FIG. 2B, some of ring-shaped electrodes 204 have a half circle cross-sectional shape while others have a quarter circle cross-sectional shape. However, the cross-sectional shapes of ring-shaped electrodes 204 shown in FIG. 2B are provided for illustrative purposes only. It is understood that ring-shaped electrodes 204 may each have the same cross-sectional shape. In addition, ring-shaped electrodes 204 may have different cross-sectional shapes and/or combinations of cross-sectional shapes in different implementations. For example, ring-shaped electrodes 204 may have circular, square, or parabolic, cross-sectional shapes in certain alternative implementations.

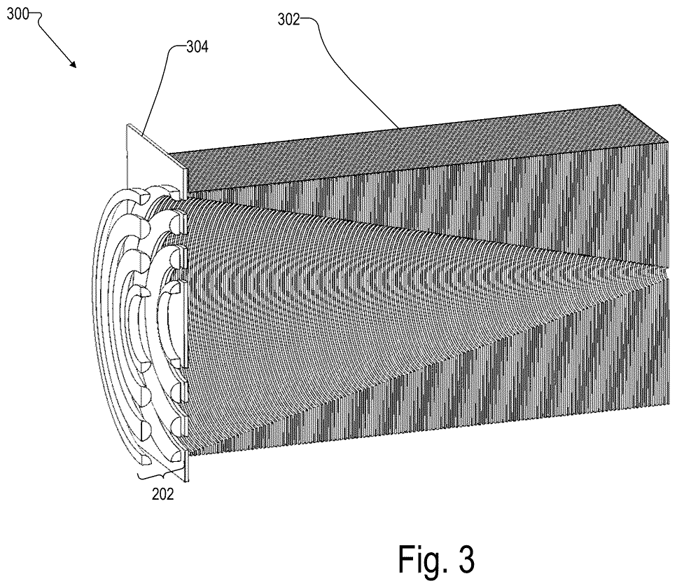

FIG. 3 shows an illustrative perspective cross-sectional view 300 that shows ion trap 202 combined with an ion guide 302. Ion guide 302 has an ion funnel configuration. However, it should be understood that an ion funnel is only one embodiment of an ion guide device. Thus, for the purpose of this disclosure, any reference to an ion funnel should be understood to be for explanatory purpose only, and that any type of ion guide may be used, such as, for example, a stacked ring guide, an ion funnel, a multipole, or the like. In some examples, ions may be pushed across the first pseudo-potential barrier at the exit of ion trap 202 and subsequently driven along the axial length of ion guide 302 by applying a static DC electric field to create an axial field in opposition to the pseudo-potential barrier at the exit of ion trap 202.

In accordance with some embodiments of the present disclosure, operation of the ion trap 202 and downstream devices (e.g., the ion guide 302, mass analyzers 104, collision cells, ion detectors 106) can be synchronized in time to enhance duty cycle. For example, the ion trap 202 can be controlled to elute ions having a particular m/z value, and a downstream mass analyzer 104 can be controlled to enable passage of those ions having the particular m/z value (based on their expected arrival time of the ions at the mass analyzer from the ion trap). Thus, in some configurations, the predominant separation principle of operation of the ion trap 202 can be based on m/z rather than other factors such as ion mobility. In these configurations, it may not be necessary to calibrate m/z with ion mobility such as by acquiring intermittent 2D mobility-m/z survey plots. In various embodiments, the ion trap 202 can be operated at a pressure in the range of 0.1 to 1 Torr.

FIG. 3 also shows a DC plate 304 located on a downstream side of ion trap 202 that functions to separate ion trap 202 from other adjacent RF and DC elements. Although only one DC plate 304 is shown in FIG. 3, it is understood that another DC plate may be provided upstream of ion trap 202 in certain examples.

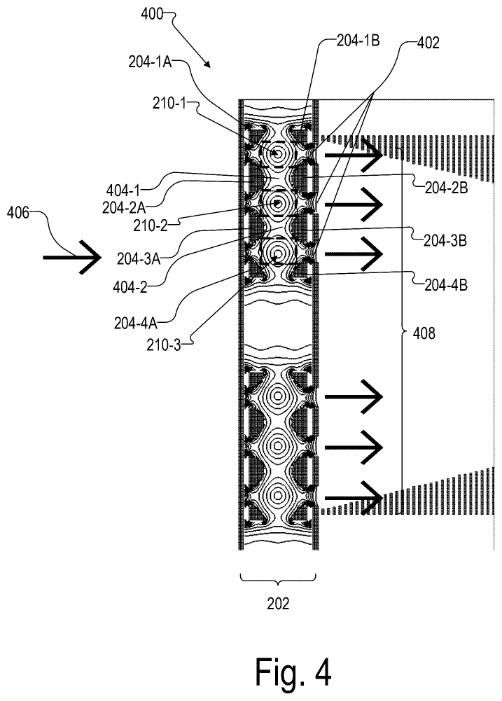

FIG. 4 shows a cross-sectional view of ion trap 202 and a portion of ion guide 302 and includes an illustrative depiction 400 of pseudo-potential barriers that may be implemented by ion trap 202. As shown in FIG. 4, electric field lines are depicted that may be indicative of RF fields that may be generated by ring-shaped electrodes when generating pseudo-potential barriers. In the example shown in FIG. 4, a first pseudo-potential barrier 402 is generated along the right side (exit side) of ion trap 202 so as to prevent ions from escaping ion trap 202 during ion accumulation. A magnitude of first pseudo-potential barrier 402 between each of the ring-shaped electrodes on the right side of ion trap 202 may be substantially the same. For example, the magnitude of first pseudo-potential barrier 402 between ring-shaped electrodes 204-1B and 204-2B may be substantially the same as the magnitude of first pseudo-potential barrier 402 between ring-shaped electrodes 204-2B and 204-3B. The magnitude of first pseudo-potential barrier 402 may be selected or set in any suitable manner. For example, increasing the amplitude of the RF voltages applied to the ring-shaped electrodes increases first pseudo-potential barrier 402.

A second pseudo-potential barrier 404-1 is generated between adjacent annular trapping volumes 210-1 and 210-2 and a third pseudo-potential barrier is generated between adjacent annular trapping volumes 210-2 and 210-3.

Second pseudo-potential barrier 404-1 and third pseudo-potential barrier 404-2 are configured to be relatively weaker than first pseudo-potential barrier 402 so that ions are prevented from migrating across first pseudo-potential barrier 402 but instead migrate across second pseudo-potential barrier 404-1 and third pseudo-potential barrier 404-2 when sufficient charge accumulates in annular trapping volume 210-3. As the number of ions increases in any given annular trapping volume 210, mutual repulsion among the ions (which tends to counteract the forces trapping ions in the annular trapping volume) increases in size. Ions seek the easiest direction of egress from a heavily-populated annular trapping volume 210 and can first move in the direction of the lowest pseudo-potential barrier. Accordingly, during accumulation, the ions may start accumulating first within third annular trapping volume 210-3 and migrate across third pseudo-potential barrier 404-2 as third annular trapping volume 210-3 begins to fill with ions. Until a space charge limit of third annular trapping volume 210-3 is exceeded, ions may remain in and continue to accumulate within third annular trapping volume 210-3. Once the space charge limit of third annular trapping volume 210-3 is exceeded, the ions may cross third pseudo-potential barrier 404-2 and begin filling second annular trapping volume 210-2. As second annular trapping volume 210-2 begins to fill with ions, the ions may accumulate within second annular trapping volume 210-2 until a space charge limit of second annular trapping volume 210-2 is exceeded. Once the space charge limit of second annular trapping volume 210-2 is exceeded, the ions may migrate across second pseudo-potential barrier 404-1 to begin filling first annular trapping volume 210-1. In this manner, ion trap 202 may successively accumulate ions from an innermost annular trapping volume to an outermost annular trapping volume. Relatively higher m/z ions experience lower pseudo-potential barriers than relatively lower m/z ions. As such, the relatively higher m/z ions may migrate across the third pseudo-potential barrier 404-2 before the relatively lower m/z ions. Likewise, the relatively higher m/z ions may migrate across second pseudo-potential barrier 404-1 before the relatively lower m/z ions. In certain alternative examples, the entrance of ion trap 202 may be located at an outermost annular trapping volume. In such examples, ion trap 202 may successively accumulate ions from the outermost trapping volume to the innermost trapping volume. In certain alternative implementations, the entrance of ion trap 202 may be located at a middle or interior annular trapping volume (e.g., annular trapping volume 210-2). In such examples, the ions may accumulate first in the middle annular trapping volume and then migrate outwardly across the second pseudo-potential barrier to accumulate within the outermost annular trapping volume and/or inwardly across the third pseudo-potential barrier to accumulate within the innermost annular trapping volume.

Second pseudo-potential barrier 404-1 and third pseudo-potential barrier 404-2 may be configured to be relatively weaker than first pseudo-potential barrier 402 in any suitable manner. For example, ring-shaped electrode 204-2A may be maintained at a lower RF than ring-shaped electrodes 204-1B and 204-2B to form second pseudo-potential barrier 404-1 between annular trapping volume 210-1 and annular trapping volume 210-2. Additionally or alternatively, the RF can be maintained at a similar value across ring-shaped electrode 204-2A and ring-shaped electrodes 204-1B and 204-2B but other features such as geometry (e.g., electrode spacing) of the ring-shaped electrodes may be designed or manipulated in the trap to cause the second pseudo-potential barrier 404-1 and third pseudo-potential barrier 404-2 to be weaker than the first pseudo-potential barrier 402.

Ion trap 202 may further include additional pseudo-potential barriers at the outermost ring-shaped electrodes (e.g., between ring-shaped electrodes 204-1A and 204-1B) and the innermost ring-shaped electrodes (e.g., between ring-shaped electrodes 204-4A and 204-4B) that prevent the ions from escaping radially. In such examples, the additional pseudo-potential barriers may be relatively stronger than second pseudo-potential barrier 404-1 and third pseudo-potential barrier 404-2.

Ion trap 202 may further include additional pseudo-potential barriers on a side of ion trap 202 (e.g., an entrance side) opposite the side with first pseudo-potential barrier 402 (e.g., an exit side). For example, an additional pseudo-potential barrier may be provided along the entrance side (e.g., upstream side) of ion trap 202 shown in FIG. 4 (e.g., between ring-shaped electrodes 204-1A, 204-2A, 204-3A, and 204-4A to contain ions and prevent the ions from escaping from the entrance side of ion trap 202. Such additional (entrance-side) pseudo-potential barriers may be relatively the same as first pseudo-potential barrier 402 but relatively stronger than second pseudo-potential barrier 404-1 and third pseudo-potential barrier 404-2. In some examples, the entrance-side pseudo-potential barrier can be lowered (reduced in strength) during a loading phase of the ion trap 202 and can be subsequently raised during a trapping phase and/or an elution phase of the ion trap 202.

In the example shown in FIG. 4, ions may be injected into ion trap 202 in an axial direction through an entrance port (not shown), as indicated by arrow 406. In certain alternative implementations, ions may be inserted into ion trap 202 orthogonally (e.g., in a radial direction). In examples where the ions are added in an axial direction, the pseudo-potential barrier created at the entrance of ion trap 202 may be less than the pseudo-potential barrier created at the exit of ion trap. For example, during axial injection, ring-shaped electrodes 204-1A and 204-2A may be maintained at a lower RF than ring-shaped electrodes 204-1B and 204-2B.

The RF fields used to generate the first and second pseudo-potential barriers may be implemented in any suitable manner. If the RF fields are established such that a quadrupolar or predominantly quadrupolar field is present in the center of the ion trap, the pseudo-potential well depth (Vₜᵣₐₚ) is inversely proportional to m/z and proportional to the amplitude of the RF voltage (V_{RF}) squared. The Vₜᵣₐₚ value may be obtained using Equation 1:

Vₜᵣₐₚ=C e V²_{RF}/(ω² m/z)
where e is the elementary charge, C is a geometric constant, and ω is the RF frequency.

According to Equation 1, high m/z ions see a lower overall Vₜᵣₐₚ barrier and consequently are the first species to exit.

Arrows 408 on the right side (exit side) of ion trap 202 shown in FIG. 4 represent the axial direction in which ions exit from ion trap 202 after accumulation.

In certain examples, an elution field of the ions at the exit of an ion trap for each of the annular trapping volumes may be substantially the same. For example, an elution field of ions for the exit of the ion trap at the first annular trapping volume may be substantially the same as the elution field of ions for the exit of the ion trap at the second annular trapping volume. This can occur in some examples when the ring-shaped electrodes 204 are arranged in a parallel configuration as described above with respect to FIG. 2B. As used herein, the “elution field” being substantially the same refers to the fact that ions of the same m/z will substantially simultaneously exit the ion trap from whatever annular trapping volume the ions are in because the first pseudopotential barrier has the same magnitude at the exit for all annular trapping volumes.

In certain examples, an ion distribution produced by ions at the exit of an ion trap for each of the annular trapping volumes may be substantially the same. As used herein, the “ion distribution” refers to the concentration or amount of ions that exit the ion trap for a given m/z at a given time. The ion distributions from each of the annular trapping volumes may be substantially the same due to the first pseudo-potential barrier having substantially the same value at the exit of each of the annular trapping volumes.

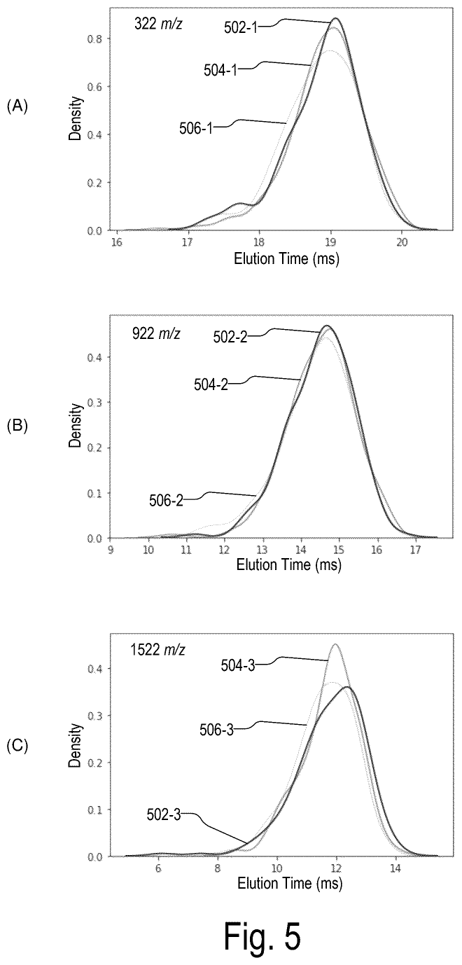

To illustrate, FIG. 5 shows illustrative graphs (A)-(C) that show observed densities of ion signals as a function of elution time for ions of different m/z in an ion trap 202 of the design illustrated in FIGS. 2A and 2B. The elution time refers to the time that elapses while ions of a given m/z exit the ion trap. Graph (A) depicts ion distributions of three annular trapping volumes for ions of m/z 322. In graph (A), curve 502-1 represents an ion distribution for a first annular trapping volume (e.g., annular trapping volume 210-1), curve 504-1 represents an ion distribution for a second annular trapping volume (e.g., annular trapping volume 210-2), and curve 506-1 represents an ion distribution for a third annular trapping volume (e.g., annular trapping volume 210-3). As shown in graph (A), the ion distributions for the different annular trapping volumes have substantially the same magnitude.

Graph (B) depicts ion distributions of three annular trapping volumes for ions of 922 m/z. In graph (B), curve 502-2 represents an ion distribution for a first annular trapping volume (e.g., annular trapping volume 210-1), curve 504-2 represents an ion distribution for a second annular trapping volume (e.g., annular trapping volume 210-2), and curve 506-2 represents an ion distribution for a third annular trapping volume (e.g., annular trapping volume 210-3). As shown in graph (B), the ion distributions for the different annular trapping volumes have substantially the same magnitude.

Graph (C) depicts ion distributions of three annular trapping volumes for ions of 1522 m/z. In graph (C), curve 502-3 represents an ion distribution for a first annular trapping volume (e.g., annular trapping volume 210-1), curve 504-3 represents an ion distribution for a second annular trapping volume (e.g., annular trapping volume 210-2), and curve 506-3 represents an ion distribution for a third annular trapping volume (e.g., annular trapping volume 210-3). As shown in graph (C), the ion distributions for the different annular trapping volumes have substantially the same magnitude.

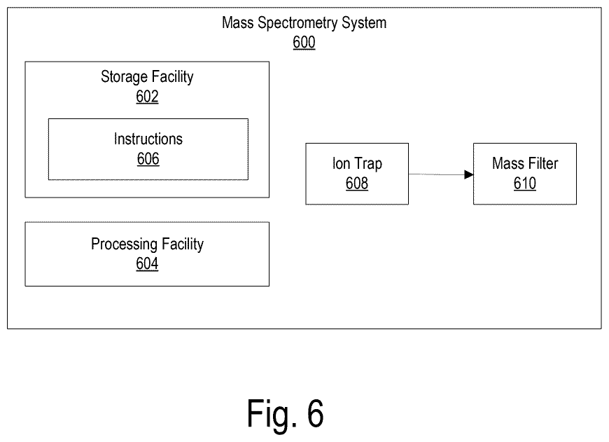

FIG. 6 shows illustrative components of a mass spectrometry system 600 that may be implemented according to principles described herein. As shown in FIG. 6, mass spectrometry system 600 may include, without limitation, a storage facility 602 and a processing facility 604 selectively and communicatively coupled to one another. Facilities 602 and 604 may each include or be implemented by hardware and/or software components (e.g., processors, memories, communication interfaces, instructions stored in memory for execution by the processors, etc.). In some examples, facilities 602 and 604 may be distributed between multiple devices and/or multiple locations as may serve a particular implementation. For example, facilities 602 and 604 may be distributed between one or more local compute resources and one or more remote compute resources communicatively coupled to the local compute resources by way of a network.

Storage facility 602 may maintain (e.g., store) executable data used by processing facility 604 to perform any of the operations described herein. For example, storage facility 602 may store instructions 606 that may be executed by processing facility 604 to perform any of the operations described herein. Instructions 606 may be implemented by any suitable application, software, code, and/or other executable data instance. Storage facility 602 may also maintain any data acquired, received, generated, managed, used, and/or transmitted by processing facility 604.

Processing facility 604 may be configured to perform (e.g., execute instructions 606 stored in storage facility 602 to perform) various processing operations described herein. It will be recognized that the operations and examples described herein are merely illustrative of the many different types of operations that may be performed by processing facility 604. In the description herein, any references to operations performed by mass spectrometry system 600 may be understood to be performed by processing facility 604 of mass spectrometry system 600. Furthermore, in the description herein, any operations performed by mass spectrometry system 600 may include mass spectrometry system 600 directing or instructing another computing system, device, or apparatus to perform the operations.

As shown in FIG. 6, mass spectrometry system 600 further includes an ion trap 608 that is provided upstream of a mass filter 610. Ion trap 608 and mass filter 610 may be configured in any suitable manner, such as in any manner described herein. In certain examples, ion trap 608 and mass filter 610 may be provided, respectively, as part of ion source 102 and mass analyzer 104 of mass spectrometer platform 100 shown in FIG. 1.

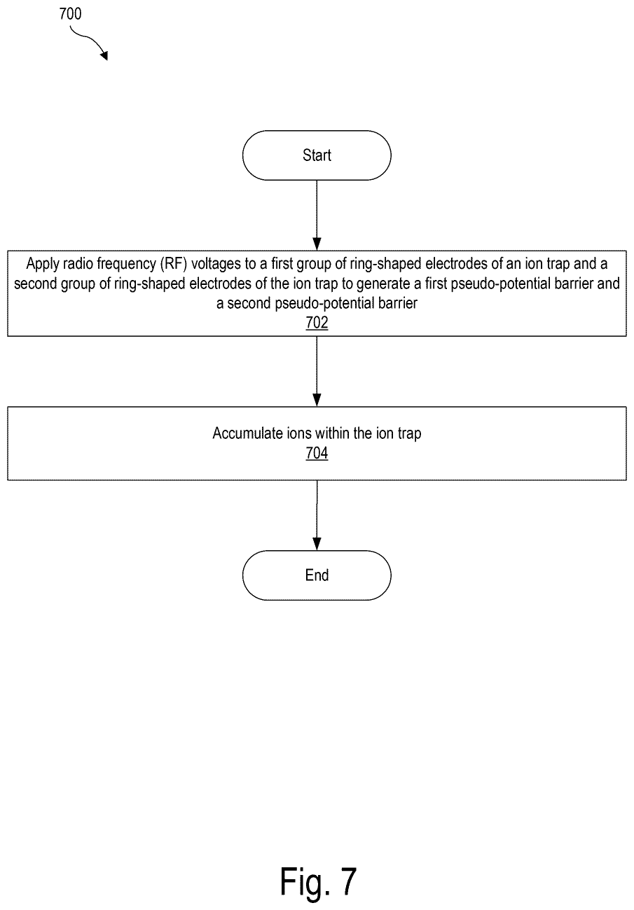

FIG. 7 shows an illustrative method 700 of storing ions that may be performed by a mass spectrometry system (e.g., mass spectrometry system 600). While FIG. 7 shows illustrative operations according to one embodiment, other embodiments may omit, add to, reorder, and/or modify any of the operations shown in FIG. 7.

At operation 702, the mass spectrometry system may apply radio frequency (RF) voltages to a first group of ring-shaped electrodes of an ion trap and a second group of ring-shaped electrodes of the ion trap to generate a first pseudo-potential barrier and a second pseudo-potential barrier. Operation 702 may be performed in any of the ways described herein.

At operation 704, the mass spectrometry system may accumulate ions within the ion trap. Operation 704 may be performed in any of the ways described herein.

While the ions are trapped within the annular trapping volumes by the pseudo-potential barriers, the ions may remain in a pseudo-equilibrium between the pseudo-potential barriers. After accumulating the ions within the annular trapping volumes, the mass spectrometry system may eject (or elute) the ions from the ion trap. This may be accomplished in any suitable manner. For example, in certain implementations, the ejecting of the ions may comprise decreasing (e.g., ramping down) a magnitude or amplitude of the RF voltages. Additionally or alternatively, the ejecting of the ions from the ion trap may comprise increasing a direct current (DC) axial gradient inside the ion trap to urge the ions over the first pseudo-potential barrier. Additionally or alternatively, the ejecting of the ions may include floating the entire ion trap up with respect to the adjacent ion guide.

Providing a DC axial gradient inside the ion trap provides an additional benefit by facilitating axial stratification based on well depth prior to ejecting the ions across the first pseudo-potential barrier. Because the DC field is m/z independent while Vₜᵣₐₚ is m/z dependent, the combined field can position ions within the trap in the order that they would exit over the first pseudo-potential barrier. Accordingly, it is possible to release the ions in an m/z dependent manner, which beneficially facilitates scheduling exit of the ions from the trap and improves sensitivity.

In certain examples, the DC axial gradient voltage may be increased in a particular manner sufficient to separate two ion species. According to Equation 1, ions with a high m/z ratio will experience a lower overall Vₜᵣₐₚ barrier. Accordingly, a relatively higher mass ion will be ejected beyond the first pseudo-potential barrier before a relatively lower mass ion. Once all the high mass ions have been ejected, the DC axial gradient voltage may be increased further to eject the relatively lower mass ions.

In certain examples where ring-shaped electrodes are arranged in a non-parallel configuration when viewed in cross section, such as described herein, the ejecting of the ions may include ejecting ions having a first m/z value from an outermost annular trapping volume (e.g., first annular trapping volume 210-1) prior to ejecting ions having a second m/z value from another annular trapping volume (e.g., second annular trapping volume 210-2 and/or third annular trapping volume 210-3). In such examples, the first m/z value is greater than the second m/z value.

In some examples, a computer program product embodied in a non-transitory computer-readable storage medium may be provided. In such examples, the non-transitory computer-readable storage medium may store computer-readable instructions in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Illustrative non-volatile storage media include, but are not limited to, read-only memory, flash memory, a solid-state drive, a magnetic storage device (e.g., a hard disk, a floppy disk, magnetic tape, etc.), ferroelectric random-access memory (“RAM”), and an optical disc (e.g., a compact disc, a digital video disc, a Blu-ray disc, etc.). Illustrative volatile storage media include, but are not limited to, RAM (e.g., dynamic RAM).

FIG. 8 shows an illustrative computing device 800 that may be specifically configured to perform one or more of the operations, methods, and processes described herein. Any of the systems, computing devices, and/or other components described herein may be implemented by computing device 800.

As shown in FIG. 8, computing device 800 may include a communication interface 802, a processor 804, a storage device 806, and an input/output (“I/O”) module 808 communicatively connected one to another via a communication infrastructure 810. While an illustrative computing device 800 is shown in FIG. 8, the components illustrated in FIG. 8 are not intended to be limiting. Additional or alternative components may be used in other embodiments. Components of computing device 800 shown in FIG. 8 will now be described in additional detail.

Communication interface 802 may be configured to communicate with one or more computing devices. Examples of communication interface 802 include, without limitation, a wired network interface (such as a network interface card), a wireless network interface (such as a wireless network interface card), a modem, an audio/video connection, and any other suitable interface.

Processor 804 generally represents any type or form of processing unit capable of processing data and/or interpreting, executing, and/or directing execution of one or more of the instructions, processes, and/or operations described herein. Processor 804 may perform operations by executing computer-executable instructions 812 (e.g., an application, software, code, and/or other executable data instance) stored in storage device 806.

Storage device 806 may include one or more data storage media, devices, or configurations and may employ any type, form, and combination of data storage media and/or device. For example, storage device 806 may include, but is not limited to, any combination of the non-volatile media and/or volatile media described herein. Electronic data, including data described herein, may be temporarily and/or permanently stored in storage device 806. For example, data representative of computer-executable instructions 812 configured to direct processor 804 to perform any of the operations described herein may be stored within storage device 806. In some examples, data may be arranged in one or more databases residing within storage device 806.

I/O module 808 may include one or more I/O modules configured to receive user input and provide user output. One or more I/O modules may be used to receive input for a single virtual experience. I/O module 808 may include any hardware, firmware, software, or combination thereof supportive of input and output capabilities. For example, I/O module 808 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 808 is configured to provide graphical data to a display for presentation to a user. The graphical data may be representative of one or more graphical user interfaces and/or any other graphical content as may serve a particular implementation.

Advantages and features of the present disclosure can be further described by the following statements:
1. An ion trap comprising: a first group of ring-shaped electrodes that are centered around an ion trap central axis and that define a first annular trapping volume, the first annular trapping volume located at a first distance from the ion trap central axis; a second group of ring-shaped electrodes that are centered around the ion trap central axis and that define a second annular trapping volume, the second annular trapping volume located at a second distance from the ion trap central axis, the second distance being less than the first distance; an entrance through which ions are added to at least one of the first annular trapping volume or the second annular trapping volume; and an exit through which the ions exit the first annular trapping volume and the second annular trapping volume in an axial direction, wherein: upon receipt of radio frequency (RF) voltages, the first group of ring-shaped electrodes and the second group of ring-shaped electrodes generate a first pseudo-potential barrier and a second pseudo-potential barrier; the first pseudo-potential barrier is positioned at the exit of the ion trap and is configured to prevent the ions within the first annular trapping volume and the ions within the second annular trapping volume from escaping the first annular trapping volume and the second annular trapping volume in the axial direction through the exit; the second pseudo-potential barrier is positioned between the first annular trapping volume and the second annular trapping volume and is configured to urge the ions within the second annular trapping volume away from the first annular trapping volume; and the second pseudo-potential barrier is weaker than the first pseudo-potential barrier.
2. The ion trap of statement 1, wherein at least two ring-shaped electrodes included in the first group of ring-shaped electrodes are also included in the second group of ring-shaped electrodes.
3. The ion trap of any of the preceding statements, wherein: the first group of ring-shaped electrodes comprises a first quadrupole formed of a first ring-shaped electrode, a second ring-shaped electrode, a third ring-shaped electrode, and a fourth ring-shaped electrode; and the second group of ring-shaped electrodes comprises a second quadrupole formed of the third ring-shaped electrode, the fourth ring-shaped electrode, a fifth ring-shaped electrode, and a sixth ring-shaped electrode.
4. The ion trap of any of the preceding statements, further comprising a third group of ring-shaped electrodes that are centered around the ion trap central axis and that define a third annular trapping volume, wherein: the third annular trapping volume is located at a third distance from the ion trap central axis, the third distance being less than the second distance; upon receipt of the RF voltages, the third group of ring-shaped electrodes generates a third pseudo-potential barrier; and the third pseudo-potential barrier is positioned between the second annular trapping volume and the third annular trapping volume and is configured to urge the ions within the third annular trapping volume away from the second annular trapping volume.
5. The ion trap of any of the preceding statements, wherein the second annular trapping volume is configured to receive the ions through the entrance and at least a portion of the ions within the second annular trapping volume preferentially migrate, across the second pseudo-potential barrier instead of the first pseudo-potential barrier, from the second annular trapping volume to the first annular trapping volume while the second annular trapping volume accumulates the ions.
6. The ion trap of any of the preceding statements, wherein the ion trap is configured such that ions are only accumulated in the first annular trapping volume after the ions migrate from the second annular trapping volume to the first annular trapping volume across the second pseudo-potential barrier.
7. The ion trap of any of the preceding statements, wherein an elution field of ions at the exit of the ion trap at the first annular trapping volume has substantially the same magnitude as an elution field of ions at the exit of the ion trap at the second annular trapping volume.
7B. The ion trap of any of the preceding statements, wherein a first imaginary plane on which lies a first portion of the first group of ring-shaped electrodes is angled with respect to a second imaginary plane on which lies a second portion of the first group of ring-shaped electrodes.
7C. The ion trap of statement 7B wherein the first portion of the first group of ring-shaped electrodes is positioned at the entrance to the ion trap and the second portion of the first group of ring-shaped electrodes is positioned at the exit to the ion trap.
7D. The ion trap of statement 7B or 7C, wherein ions having a first m/z value are ejected from the first annular trapping volume prior to ejection of ions having a second m/z value from the second annular trapping volume, the first m/z value being greater than the second m/z value.
8. A mass spectrometry system comprising: a mass filter; and an ion trap positioned upstream of the mass filter, the ion trap comprising: a first group of ring-shaped electrodes that are centered around an ion trap central axis and that define a first annular trapping volume, the first annular trapping volume located at a first distance from the ion trap central axis; and a second group of ring-shaped electrodes that are centered around an ion trap central axis and that define a second annular trapping volume, the second annular trapping volume located at a second distance from the ion trap central axis, the second distance being less than the first distance.
9. The mass spectrometry system of statement 8, wherein: the ion trap further comprises: an entrance through which ions are added to at least one of the first annular trapping volume or the second annular trapping volume; and an exit through which the ions exit the first annular trapping volume and the second annular trapping volume in an axial direction; upon receipt of radio frequency (RF) voltages, the first group of ring-shaped electrodes and the second group of ring-shaped electrodes generate a first pseudo-potential barrier and a second pseudo-potential barrier; the first pseudo-potential barrier is positioned at the exit of the ion trap and is configured to prevent the ions within the first annular trapping volume and the ions within the second annular trapping volume from escaping the first annular trapping volume and the second annular trapping volume in the axial direction through the exit; the second pseudo-potential barrier is positioned between the first annular trapping volume and the second annular trapping volume and is configured to urge the ions within the second annular trapping volume away from the first annular trapping volume; and the second pseudo-potential barrier is weaker than the first pseudo-potential barrier.
10. The mass spectrometry system of any of the preceding statements, further comprising a third group of ring-shaped electrodes that are centered around the ion trap central axis and that define a third annular trapping volume, wherein: the third annular trapping volume is located at a third distance from the ion trap central axis, the third distance being less than the second distance; upon receipt of the RF voltages, the third group of ring-shaped electrodes generates a third pseudo-potential barrier; and the third pseudo-potential barrier is positioned between the second annular trapping volume and the third annular trapping volume and is configured to urge the ions within the third annular trapping volume away from the second annular trapping volume.
11. The mass spectrometry system of any of the preceding statements, wherein at least two ring-shaped electrodes included in the first group of ring-shaped electrodes are also included in the second group of ring-shaped electrodes.
12. The mass spectrometry system of any of the preceding statements, wherein an elution field of ions at an exit of the ion trap at the first annular trapping volume has substantially the same magnitude as an elution field of ions at the exit of the ion trap at the second annular trapping volume.
13. A method comprising: applying, by a mass spectrometry system, radio frequency (RF) voltages to a first group of ring-shaped electrodes of an ion trap and a second group of ring-shaped electrodes of the ion trap to generate a first pseudo-potential barrier and a second pseudo-potential barrier, wherein: the first group of ring-shaped electrodes are centered around a central axis of the ion trap and define a first annular trapping volume; the second group of ring-shaped electrodes are centered around the central axis of the ion trap and define a second annular trapping volume; the first group of ring-shaped electrodes and the second group of ring-shaped electrodes are concentric about the central axis of the ion trap; the first pseudo-potential barrier is positioned at an exit of the ion trap and is configured to prevent ions from escaping the ion trap in an axial direction through the exit; the second pseudo-potential barrier is positioned between the first annular trapping volume and the second annular trapping volume; and the second pseudo-potential barrier is weaker than the first pseudo-potential barrier; and accumulating, by the mass spectrometry system, ions within the ion trap.
14. The method of statement 13, wherein the accumulating of the ions within the ion trap includes the ions entering the ion trap from a single entrance point.
15. The method of any of the preceding statements, wherein the accumulating of the ions within the ion trap includes accumulating ions within the second annular trapping volume before accumulating the ions within the first annular trapping volume.
16. The method of any of the preceding statements, further comprising ejecting, by the mass spectrometry system and based on m/z of the ions, the ions from the ion trap.
17. The method of any of the preceding statements, wherein the ejecting of the ions include ejecting ions having a first m/z value from the first annular trapping volume prior to ejecting ions having a second m/z value from the second annular trapping volume, the first m/z value being greater than the second m/z value.
18. The method of any of the preceding statements, wherein the ions are simultaneously ejected from the exit of the ion trap at the first annular trapping volume and the exit of the ion trap at the second annular trapping volume.
19. The method of any of the preceding statements, wherein the ejecting of the ions from the ion trap comprises at least one of: decreasing a magnitude of the RF voltages; or increasing a direct current (DC) axial gradient inside the ion trap to force the ions over the first pseudo-potential barrier.
20. The method of any of the preceding statements, further comprising applying, by the mass spectrometry system, a direct current (DC) axial gradient across the first annular trapping volume and the second annular trapping volume in the axial direction to provide axial stratification of ions within the first annular trapping volume and the second annular trapping volume based on m/z of the ions.
21. An ion trap comprising: a first annular quadrupole; and a second annular quadrupole, wherein the first annular quadrupole and the second annular quadrupole are concentric.
22. An ion trap comprising: a first set of concentric annular electrodes; and a second set of concentric annular electrodes opposite the first set of concentric annular electrodes in an axial direction.

In the preceding description, various illustrative embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. An ion trap comprising:
a first group of ring-shaped electrodes that are centered around an ion trap central axis and that define a first annular trapping volume, the first annular trapping volume located at a first distance from the ion trap central axis;
a second group of ring-shaped electrodes that are centered around the ion trap central axis and that define a second annular trapping volume, the second annular trapping volume located at a second distance from the ion trap central axis, the second distance being less than the first distance;
an entrance through which ions are added to at least one of the first annular trapping volume or the second annular trapping volume; and
an exit through which the ions exit the first annular trapping volume and the second annular trapping volume in an axial direction,
wherein:
upon receipt of radio frequency (RF) voltages, the first group of ring-shaped electrodes and the second group of ring-shaped electrodes generate a first pseudo-potential barrier and a second pseudo-potential barrier;
the first pseudo-potential barrier is positioned at the exit of the ion trap and is configured to prevent the ions within the first annular trapping volume and the ions within the second annular trapping volume from escaping the first annular trapping volume and the second annular trapping volume in the axial direction through the exit;
the second pseudo-potential barrier is positioned between the first annular trapping volume and the second annular trapping volume and is configured to urge the ions within the second annular trapping volume away from the first annular trapping volume; and
the second pseudo-potential barrier is weaker than the first pseudo-potential barrier.

2. The ion trap of claim 1, wherein at least two ring-shaped electrodes included in the first group of ring-shaped electrodes are also included in the second group of ring-shaped electrodes.

3. The ion trap of claim 2, wherein:
the first group of ring-shaped electrodes comprises a first quadrupole formed of a first ring-shaped electrode, a second ring-shaped electrode, a third ring-shaped electrode, and a fourth ring-shaped electrode; and
the second group of ring-shaped electrodes comprises a second quadrupole formed of the third ring-shaped electrode, the fourth ring-shaped electrode, a fifth ring-shaped electrode, and a sixth ring-shaped electrode.

4. The ion trap of claim 1, further comprising a third group of ring-shaped electrodes that are centered around the ion trap central axis and that define a third annular trapping volume,
wherein:
the third annular trapping volume is located at a third distance from the ion trap central axis, the third distance being less than the second distance;
upon receipt of the RF voltages, the third group of ring-shaped electrodes generates a third pseudo-potential barrier; and
the third pseudo-potential barrier is positioned between the second annular trapping volume and the third annular trapping volume and is configured to urge the ions within the third annular trapping volume away from the second annular trapping volume.

5. The ion trap of claim 1, wherein the second annular trapping volume is configured to receive the ions through the entrance and at least a portion of the ions within the second annular trapping volume preferentially migrate, across the second pseudo-potential barrier instead of the first pseudo-potential barrier, from the second annular trapping volume to the first annular trapping volume while the second annular trapping volume accumulates the ions.

6. The ion trap of claim 5, wherein the ion trap is configured such that ions are only accumulated in the first annular trapping volume after the ions migrate from the second annular trapping volume to the first annular trapping volume across the second pseudo-potential barrier.

7. The ion trap of claim 1, wherein an elution field of ions at the exit of the ion trap at the first annular trapping volume has substantially the same magnitude as an ion elution field of ions at the exit of the ion trap at the second annular trapping volume.

8. A mass spectrometry system comprising:
a mass filter; and
an ion trap positioned upstream of the mass filter, the ion trap comprising:
a first group of ring-shaped electrodes that are centered around an ion trap central axis and that define a first annular trapping volume, the first annular trapping volume located at a first distance from the ion trap central axis; and
a second group of ring-shaped electrodes that are centered around an ion trap central axis and that define a second annular trapping volume, the second annular trapping volume located at a second distance from the ion trap central axis, the second distance being less than the first distance.

9. The mass spectrometry system of claim 8, wherein:
the ion trap further comprises:
an entrance through which ions are added to at least one of the first annular trapping volume or the second annular trapping volume; and
an exit through which the ions exit the first annular trapping volume and the second annular trapping volume in an axial direction;
upon receipt of radio frequency (RF) voltages, the first group of ring-shaped electrodes and the second group of ring-shaped electrodes generate a first pseudo-potential barrier and a second pseudo-potential barrier;
the first pseudo-potential barrier is positioned at the exit of the ion trap and is configured to prevent the ions within the first annular trapping volume and the ions within the second annular trapping volume from escaping the first annular trapping volume and the second annular trapping volume in the axial direction through the exit;
the second pseudo-potential barrier is positioned between the first annular trapping volume and the second annular trapping volume and is configured to urge the ions within the second annular trapping volume away from the first annular trapping volume; and
the second pseudo-potential barrier is weaker than the first pseudo-potential barrier.

10. The mass spectrometry system of claim 8, further comprising a third group of ring-shaped electrodes that are centered around the ion trap central axis and that define a third annular trapping volume,
wherein:
the third annular trapping volume is located at a third distance from the ion trap central axis, the third distance being less than the second distance;
upon receipt of the RF voltages, the third group of ring-shaped electrodes generates a third pseudo-potential barrier; and
the third pseudo-potential barrier is positioned between the second annular trapping volume and the third annular trapping volume and is configured to urge the ions within the third annular trapping volume away from the second annular trapping volume.

11. The mass spectrometry system of claim 8, wherein at least two ring-shaped electrodes included in the first group of ring-shaped electrodes are also included in the second group of ring-shaped electrodes.

12. The mass spectrometry system of claim 8, wherein an elution field of ions at an exit of the ion trap at the first annular trapping volume has substantially the same magnitude as an elution field of ions at the exit of the ion trap at the second annular trapping volume.

13. A method comprising:
applying, by a mass spectrometry system, radio frequency (RF) voltages to a first group of ring-shaped electrodes of an ion trap and a second group of ring-shaped electrodes of the ion trap to generate a first pseudo-potential barrier and a second pseudo-potential barrier,
wherein:
the first group of ring-shaped electrodes are centered around a central axis of the ion trap and define a first annular trapping volume;
the second group of ring-shaped electrodes are centered around the central axis of the ion trap and define a second annular trapping volume;
the first group of ring-shaped electrodes and the second group of ring-shaped electrodes are concentric about the central axis of the ion trap;
the first pseudo-potential barrier is positioned at an exit of the ion trap and is configured to prevent ions from escaping the ion trap in an axial direction through the exit;
the second pseudo-potential barrier is positioned between the first annular trapping volume and the second annular trapping volume; and
the second pseudo-potential barrier is weaker than the first pseudo-potential barrier; and
accumulating, by the mass spectrometry system, ions within the ion trap.

14. The method of claim 13, wherein the accumulating of the ions within the ion trap includes the ions entering the ion trap from a single entrance point.

15. The method of claim 13, wherein the accumulating of the ions within the ion trap includes accumulating ions within the second annular trapping volume before accumulating the ions within the first annular trapping volume.

16. The method of claim 13, further comprising ejecting, by the mass spectrometry system and based on m/z of the ions, the ions from the ion trap.

17. The method of claim 16, wherein the ejecting of the ions includes ejecting ions having a first m/z value from the first annular trapping volume prior to ejecting ions having a second m/z value from the second annular trapping volume, the first m/z value being greater than the second m/z value.

18. The method of claim 16, wherein the ions are simultaneously ejected from the exit of the ion trap at the first annular trapping volume and the exit of the ion trap at the second annular trapping volume.

19. The method of claim 16, wherein the ejecting of the ions from the ion trap comprises at least one of:
decreasing a magnitude of the RF voltages; or
increasing a direct current (DC) axial gradient inside the ion trap to force the ions over the first pseudo-potential barrier.

20. The method of claim 13, further comprising applying, by the mass spectrometry system, a direct current (DC) axial gradient across the first annular trapping volume and the second annular trapping volume in the axial direction to provide axial stratification of ions within the first annular trapping volume and the second annular trapping volume based on m/z of the ions.
